(19) United States
(12) Patent Application Publication
(10) Pub. No.: US 2015/0042448 A1
(43) Pub. Date: Feb. 12, 2015

(54) APPARATUS AND METHOD FOR MULTILAYERED MUSIC PLAYBACK BASED ON WIRELESS DEVICE DATA

(71) Applicant: Beamz Interactive, Inc., Scottsdale, AZ (US)

(72) Inventors: Bardia Dejban, Calabasas, CA (US); Shannon Dejban, Calabasas, CA (US); Gary Bencar, Holualoa, HI (US); Dave Sandler, Saint James, NY (US); Charles Mollo, Scottsdale, AZ (US)

(73) Assignee: Beamz Interactive, Inc., Scottsdale, AZ (US)

(21) Appl. No.: 14/165,416

(22) Filed: Jan. 27, 2014

Related U.S. Application Data
(63) Continuation-in-part of application No. 14/088,178, filed on Nov. 22, 2013.
(60) Provisional application No. 61/863,824, filed on Aug. 8, 2013.

(51) Int. Cl. G06F 3/16; G08C 17/02

(52) U.S. Cl. CPC G06F 3/165; G08C 17/02
USPC 340/4.42

(57) ABSTRACT

Method and apparatus of operating an electronic device for playback of a multilayered media file are provided. The method includes receiving device data from a triggering device via a wireless protocol, the device data related to a plurality of triggers of the triggering device, each of the triggers is associated with a distinct layer of a plurality of layers of the multilayered media file. The method further includes controlling playback of the plurality of layers of media associated with the multilayered media file based on the device data.

### CROSS-REFERENCE TO RELATED APPLICATION(S) AND CLAIM OF PRIORITY

The present application is a continuation in part of U.S. patent application Ser. No. 14/088,178, filed Nov. 22, 2013, entitled “APPARATUS AND METHOD FOR MULTILAYERED MUSIC PLAYBACK”. The present application claims priority to U.S. Provisional Patent Application Ser. No. 61/863,824, filed Aug. 8, 2013, entitled “APPARATUS AND METHOD FOR LAYERED MUSIC PLAYBACK”; the content of the above-identified patent document is incorporated herein by reference.

### TECHNICAL FIELD

The present application relates generally to playing media, more specifically, to multilayered media.

### BACKGROUND

Music includes several layers, such as vocals, guitar, drums, etc. Each layer can have a unique sound and may share a similar tempo and pace. Combined, the layers of music form a musical composition.

Playback applications allow digital devices to play music and videos. Playback applications generally play entire compositions that include several layers of music. As playback applications grow more complex, there is a need for controlling the playback of individual layers of music.

### SUMMARY

A method of operating an electronic device for playback of a multilayered media file is provided. The method includes receiving device data from a triggering device via a wireless protocol, the device data related to a plurality of triggers of the triggering device, each of the triggers is associated with a distinct layer of a plurality of layers of the multilayered media file. The method further includes controlling playback of the plurality of layers of media associated with the multilayered media file based on the device data.

A method of a triggering device used for playback of a multilayered media file is provided. The method includes transmitting device data from a triggering device via a wireless protocol. The device data related to a plurality of triggers of the triggering device. Each of the triggers is associated with a distinct layer of a plurality of layers of the multilayered media file. An electronic device that receives the device data controls playback of the plurality of layers of media associated with the multilayered media file based on the device data.

An apparatus for playback of a multilayered media file is provided. The apparatus includes a receiver configured to receive device data from a triggering device via a wireless protocol. The device data related to a plurality of triggers of the triggering device. Each of the triggers is associated with a distinct layer of a plurality of layers of the multilayered media file. The apparatus further includes one or more processors configured to control playback of the plurality of layers of media associated with the multilayered media file based on the device data.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example electronic device according to embodiments of the present disclosure;

FIG. 2 illustrates a diagram of a system for multilayered media playback in accordance with embodiments of the present disclosure;

FIG. 3 illustrates a system for multilayered music playback based on wireless device data according to embodiments of the present disclosure;

FIG. 4 illustrates a packet encapsulating device data in accordance with embodiments of the present disclosure;

FIG. 5 illustrates a graphical user interface (GUI) for multilayered media playback in accordance with embodiments of the present disclosure;

FIG. 6 illustrates a flowchart for multilayered music playback based on wireless device data; and

FIG. 7 illustrates a flowchart for multilayered music playback based on wireless device data.

### DETAILED DESCRIPTION

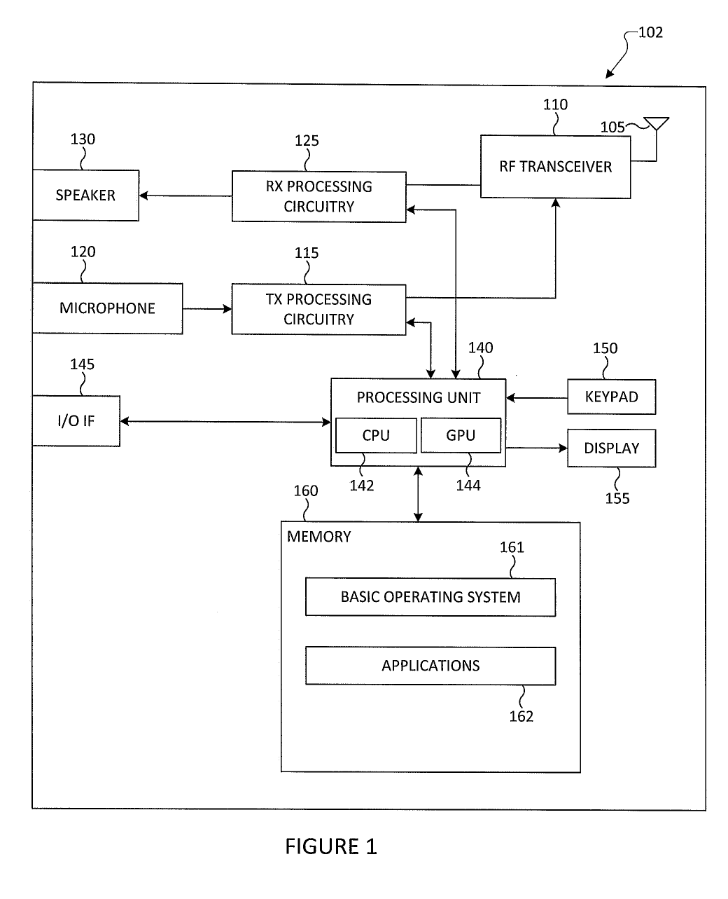

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

FIG. 1 illustrates an example electronic device 102 according to embodiments of the present disclosure. The embodiment of the electronic device 102 shown in FIG. 1 is for illustration only. Other embodiments of an electronic device could be used without departing from the scope of this disclosure.

The electronic device 102 includes an antenna 105, a radio frequency (RF) transceiver 110, transmit (TX) processing circuitry 115, a microphone 120, and receive (RX) processing circuitry 125. The electronic device 102 also includes a speaker 130, a processing unit 140, an input/output (I/O) interface (IF) 145, a keypad 150, a display 155, and a memory 160. The electronic device 102 could include any number of each of these components.

The processing unit 140 includes processing circuitry configured to execute instructions, such as instructions stored in the memory 160 or internally within the processing unit 140. The memory 160 includes a basic operating system (OS) program 161 and one or more applications 162. The electronic device 102 could represent any suitable device. In particular embodiments, the electronic device 102 represents a mobile telephone, smartphone, personal digital assistant, tablet computer, a touchscreen computer, and the like. The electronic device 102 plays multilayered media.

The RF transceiver 110 receives, from the antenna 105, an incoming RF signal transmitted by a base station or other device in a wireless network. The RF transceiver 110 down-converts the incoming RF signal to produce an intermediate frequency (IF) or baseband signal. The IF or baseband signal is sent to the RX processing circuitry 125, which produces a processed baseband signal (such as by filtering, decoding, and/or digitizing the baseband or IF signal). The RX processing circuitry 125 can provide the processed baseband signal to the speaker 130 (for voice data) or to the processing unit 140 for further processing (such as for web browsing or other data). The RF transceiver could also be an infrared (IR) transceiver, and limitation to the type of transceiver is not to be inferred.

The TX processing circuitry 115 receives analog or digital voice data from the microphone 120 or other outgoing baseband data (such as web data, e-mail, or interactive video game data) from the processing unit 140. The TX processing circuitry 115 encodes, multiplexes, and/or digitizes the outgoing baseband data to produce a processed baseband or IF signal. The RF transceiver 110 receives the outgoing processed baseband or IF signal from the TX processing circuitry 115 and up-converts the baseband or IF signal to an RF signal that is transmitted via the antenna 105.

In some embodiments, the processing unit 140 includes one or more processors, such as central processing unit (CPU) 142 and graphics processing unit (GPU) 144, embodied in one or more discrete devices. In some embodiments, the CPU 142 and the GPU 144 are implemented as one or more integrated circuits disposed on one or more printed circuit boards. The memory 160 is coupled to the processing unit 140. In some embodiments, part of the memory 160 represents a random access memory (RAM), and another part of the memory 160 represents a Flash memory acting as a read-only memory (ROM).

In some embodiments, the memory 160 is a computer readable medium that stores program instructions to play multilayered media. When the program instructions are executed by the processing unit 140, the program instructions cause one or more of the processing unit 140, CPU 142, and GPU 144 to execute various functions and programs in accordance with embodiments of this disclosure.

The processing unit 140 executes the basic OS program 161 stored in the memory 160 in order to control the overall operation of electronic device 102. For example, the processing unit 140 can control the RF transceiver 110, RX processing circuitry 125, and TX processing circuitry 115 in accordance with well-known principles to control the reception of forward channel signals and the transmission of reverse channel signals.

The processing unit 140 is also capable of executing other processes and programs resident in the memory 160, such as operations for playing multilayered media as described in more detail below. The processing unit 140 can also move data into or out of the memory 160 as required by an executing process. In some embodiments, the processing unit 140 is configured to execute a plurality of applications 162. The processing unit 140 can operate the applications 162 based on the OS program 161 or in response to a signal received from a base station. The processing unit 140 is coupled to the I/O interface 145, which provides electronic device 102 with the ability to connect to other devices, such as laptop computers, handheld computers, and server computers. The I/O interface 145 is the communication path between these accessories and the processing unit 140.

The processing unit 140 is also optionally coupled to the keypad 150 and the display unit 155. An operator of electronic device 102 uses the keypad 150 to enter data into electronic device 102. The display 155 may be a liquid crystal display, light emitting diode (LED) display, or other display capable of rendering text and/or at least limited graphics from web sites. Display unit 155 may be a touchscreen which displays keypad 150. Alternate embodiments may use other types of input/output devices and displays.

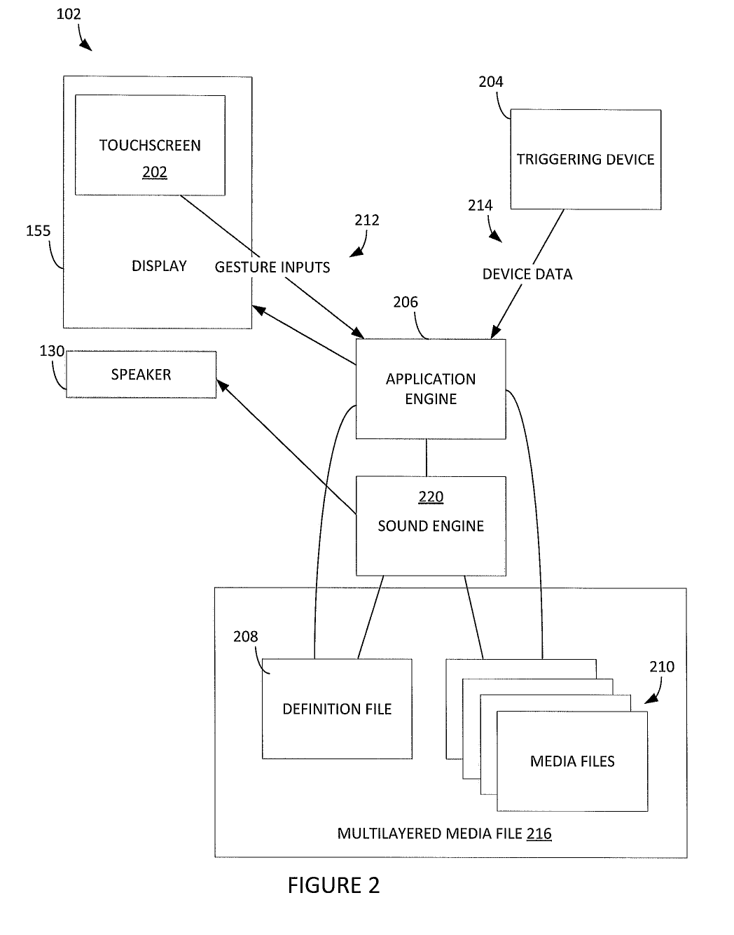

FIG. 2 illustrates a diagram of a system for multilayered media playback in accordance with embodiments of the present disclosure. The system of FIG. 2 can be implemented in electronic device 102 and embodied as one of a computer, a smart phone, a tablet, a touchscreen computer, and the like. Application engine 206 receives one or more of gesture inputs 212 from touchscreen 202 of display unit 155, and may also receive device data 214 from triggering device 204. Application engine 206 controls playback of media files 210 that are combined to form multilayered media file 216 based on one or more of gesture inputs 212, device data 214, and definition file 208 via sound engine 220.

Gesture inputs 212 include one or more touch gestures that indicate when and how touchscreen 202 is being touched. Gesture inputs 212 include a tap gesture, a long press gesture, and a drag gesture. With a tap gesture or a long press gesture, a touch starts and ends at substantially the same point on touchscreen 202 on display 155 of electronic device 102. With a tap gesture, the touch is held at substantially the same point on touch screen 202 on display 155 for a substantially short period of time, such as with a threshold for the short period of time of 0.5 seconds or less. With a long press gesture, the touch is held at substantially the same point on touch screen 202 on display 155 for a longer period of time, such as with a threshold for the longer period of time of 0.5 seconds or more. Additional thresholds may be used for a long press gesture with each threshold associated with a different action to be taken by the application 162. With a drag gesture, the touch is at least partially moved while it is being held on touchscreen 202 of display 155 of electronic device 102 and is held until the touch is released.

Output from application engine 206 is displayed on the display 155 and output from sound engine 220 is played on speaker 130. The combination of application engine 206 and sound engine 220 form an application, such as application 162. Display 155 comprises touchscreen 202. When displayed, output from application engine 206 can be shown to simulate triggering device 204 on display 155.

Multilayered media file 216 comprises a plurality of musical programs or layers, such as media files 210 that each comprises one or more audio files and video files. Multilayered media file 216 can be downloaded from the Internet and includes definition file 208. Each of the musical programs comprises a subset of a predetermined musical composition, shown in FIG. 2 as media files 210, which are also referred to as a layer of media. Each of the musical programs or layers of media is correlated to each other and comprises sound elements configured to generate sympathetic musical sounds. A trigger can be associated with a musical program to control the timing and playback of the musical program. When multiple media files are played together, an entire song or composition that incorporates each of the layers of media files 210 can be heard and seen via display 155 and speaker 130. Application engine 206 and sound engine 220 control which media files 210 of multilayered media file 216 are played and when media files 210 are played based on gesture inputs 212, device data 214, and definition file 208. Certain media files 210 can lasts an entire length of the song, whereas other media files 210 may last for a shorter duration, and can be referred to as a one-shot. Multilayered media file 216 can be an archive file comprising additional files. In certain embodiments, multilayered media file 216 is derived from a single MP3 or WAV file.

Definition file 208 describes media files 210 and one or more beam layouts for application engine 206 and sound engine 220. Based on the information of definition file 208, application engine 206 and sound engine 220 determine specific timings for when media files 210 are played based on one or more of gesture inputs 212 and device data 214.

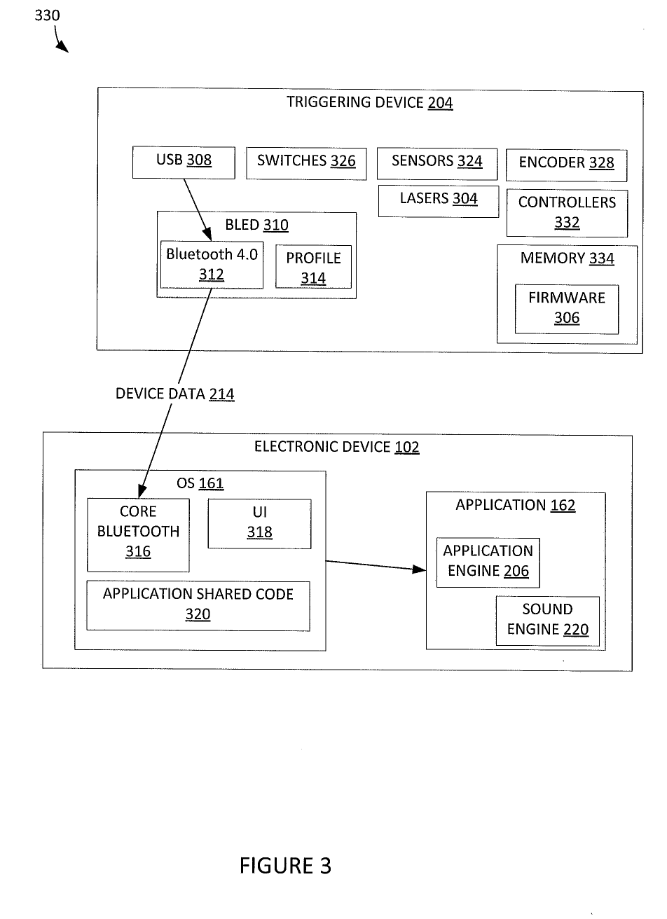

FIG. 3 illustrates a system for multilayered music playback based on wireless device data according to embodiments of the present disclosure. The embodiments of electronic device 102 and triggering device 302 shown in FIG. 3 are for illustration only. Other embodiments of an electronic device and a triggering device could be used without departing from the scope of this disclosure.

System 330 includes triggering device 204 and electronic device 102. System 330 plays back a multilayered media file, such as multilayered media file 216, via electronic device 102. The layers or musical programs of multilayered media file 216 are controlled via device data transmitted and received between triggering device 204 and electronic device 102 via a wireless connection. The wireless connection is in accordance with a wireless personal area network (WPAN) protocol, such as Bluetooth Low Energy (BLE).

Triggering device 204 is a portable handheld device that can be wirelessly connected to electronic device 102 to control playback of multilayered media files. Triggering device 204 receives user inputs that are communicated wirelessly to electronic device 102. Triggering device 204 includes lasers 304, memory 334, universal serial bus (USB) controller 308, sensors 324, switches 326, encoder 328, and BLE device 310. The components of triggering device 204 can be implemented on a single semiconductor device or on a plurality of discrete semiconductor devices.

Lasers 304 are contained within triggering device 302 to provide beams of light external to triggering device 204. Lasers 304 provide visible light. Each beam of light is directed to one of sensors 324.

Sensors 324 detect light from lasers 304. Sensors 324 convert an optical signal from laser 304 into an electrical signal used to indicate a user input.

In conjunction, lasers 304 and sensors 324 operate to provide a beam break system. A beam of light from a laser 304 is directed to a sensor 324 that receives the beam of light. When sensor 324 receives the beam of light, this is translated into a binary one to indicate that the beam of light is being received by sensor 324. When the beam of light is not received by sensor 324, this is translated into a binary zero to indicate the beam of light is not being received by sensor 324. A user can break the beam by placing an object, such as a finger, hand, pen, etc., between one of lasers and 304 and a respective one of sensors 324 to prevent the beam from the laser from reaching the sensor. The state of the sensor is communicated to electronic device 102 and is used by electronic device 102 to control playback of a layer of multilayered media.

Universal serial bus (USB) controller 308 is a discrete semiconductor device or is part of a discrete semiconductor device within triggering device 204. USB controller 308 receives device data related to one or more switches 326, encoder 328, and sensors 324 and transmits the device data in accordance with the USB protocol to BLE device 310.

BLE device 310 is a discrete semiconductor device or is part of a discrete semiconductor device within triggering device 204. BLE device 310 receives device data from USB controller 308 and wirelessly transmits device data 214 to electronic device 102 in accordance with the BLE protocol. BLE device 310 includes Bluetooth 4.0 protocol stack 312 and profile 314.

Bluetooth 4.0 protocol stack 312 is software that allows for transmitting and receiving data via the BLE protocol. Bluetooth 4.0 protocol stack 312 receives device data 214 of triggering device 204 and transmits device data 214 via the BLE protocol to electronic device 102.

Profile 314 is software that defines how data is communicated via the BLE protocol. Profile 314 defines triggering device 204 as a human interface device (HID).

Switches 326 are one or more electromechanical switches or buttons. Switches 326 convert mechanical inputs from a user of triggering device 204 into electrical signals that define a portion of device data 214. Switches 326 include a mute button, a record button, a volume down button, a volume up button, a rhythm button, a last song button, a swap button, and a next song button. The mute button allows a user to indicate whether playback of a multilayered media file should be muted. The record button allows a user to indicate whether playback of a multilayered media file should be recorded. The volume down button allows a user to indicate whether volume of playback of a multilayered media file should be decreased. The volume up button allows a user to indicate whether volume of playback of a multilayered media file should be increased. The rhythm button allows a user to indicate whether a rhythm layer of a multilayered media file should be played. The last song button allows a user to switch from playing a current song to a previous song. The swap button allows a user to swap the functionality of one or more beams or triggers. The next song button allows a user to switch from playing a current song to a next song.

Encoder 328 digitally encodes a user input to a plurality of bits. To increase volume, encoder 328 outputs a hexadecimal value of 0x01 (1). To decrease volume, encoder 328 outputs a hexadecimal value of 0xFF (−1). When neither an increase nor a decrease is indicated, encoder 328 outputs a hexadecimal value of 0x00 (0). In particular embodiments, when a sensor bit of sensor status payload 404 indicates a trigger associated with the sensor bit is activated, changes to the plurality of encoder bits are associated with a change of an attribute of a layer associated with the trigger. For example, when a beam is broken, changes to the encoder can be used to change a volume attribute of the layer or musical program associated with the beam.

Controllers 332 include one or more electronic controllers that execute programs and instructions stored in memory 334 in order to control the overall operation of triggering device 204. For example, Controllers 332 can control lasers 304, sensors 324, switches 326, and encoder 328 to detect user inputs that are used to control playback of multilayered media.

Memory 334 is a computer readable medium that stores program instructions, embodied as firmware 306, to receive user inputs and transmit device data. When the program instructions are executed by controllers 332, the program instructions cause one or more of the controllers 332 to execute various functions and programs in accordance with embodiments of this disclosure. Memory 334 includes firmware 306.

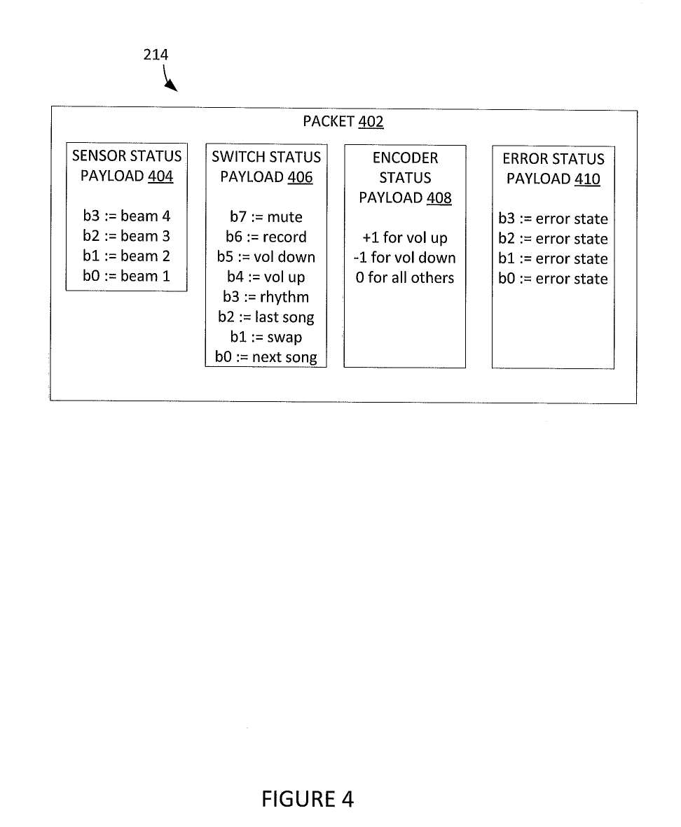

Device data 214 is wirelessly communicated between triggering device 204 and electronic device 102. When transmitted, device data 214 can be in the form of a packet, such as packet 402 described in FIG. 4. Device data 214 includes device data related to one or more of sensor status, switch status, encoder status, and error status.

Electronic device 102 could represent any suitable device. In particular embodiments, the electronic device 102 represents a mobile telephone, smartphone, personal digital assistant, tablet computer, a touchscreen computer, a desktop computer, and the like. The electronic device 102 plays multilayered media and includes OS 161 and application 162.

OS 161 includes program instructions to control the overall operation of electronic device 102. OS 161 includes core Bluetooth protocol stack 316, user interface (UI) 318, and application shared code 320.

Bluetooth protocol stack 316 is software that allows for transmitting and receiving data via the BLE protocol. Bluetooth protocol stack 316 receives device data 214 from triggering device 204 and allows for application 162 to read and use device data 214.

UI 318 is a part of OS 161 that allows a user to interact with the applications and programs of electronic device 102. UI 318 allows a user to control features and functions related to playback of multilayered media via application 162.

Application shared code 320 is code that is shared between applications to perform features and functions of electronic device 102. Application 162 can use portions of application shared code 320 that relate to Bluetooth protocol stack 316 and UI 318 to receive device data 214 and output media based on device data 214.

Application 162 includes application engine 206 and sound engine 220. Application engine receives device data 214, which is used by application engine 206 and sound engine 220 to control playback of multilayered media.

FIG. 4 illustrates a packet encapsulating device data, in accordance with embodiments of the present disclosure. The embodiment of packet 402 shown in FIG. 4 is for illustration only. Other embodiments of a packet encapsulating data could be used without departing from the scope of this disclosure.

Packet 402 is a data packet formed in accordance with an HID profile of one or more of USB and BLE protocols. Packet 402 includes sensor status payload 404, switch status payload 406, encoder status payload 408, and error status payload 410.

Sensor status payload 404 includes a plurality of bits b0 through b3. Plurality of bits b0 through b3 each indicates a state of a sensor, such as one of sensors 324. The state of sensors 324 indicate user inputs used to control multilayered media playback.

Switch status payload 406 includes a plurality of bits b0 through b7. Plurality of bits b0 through b7 of switch status payload 406 indicates a state of one or more switches, such as switches 326, of triggering device 204. The value of bits b0 through b7 of switch status payload 406 indicate user inputs used to control multilayered media playback.

Encoder status payload 408 includes a byte (eight bits). The byte of encoder status payload 408 indicates a change to a volume of multilayered media playback. A hexadecimal value of 0x01 (1) indicates volume is to be increased by one unit. A hexadecimal value of 0xFF (−1) indicates a volume is to be decreased by one unit. A hexadecimal value of 0x00 (0) indicates no change is to be made to a volume.

Error status payload 410 includes a plurality of bits b0 through b3. Plurality of bits b0 through b3 each indicates an error state of a sensor related to triggering device 204. In particular embodiments, each bit indicates a particular error status. Additionally, particular embodiments can use one or more groups of bits to encode multiple error statuses.

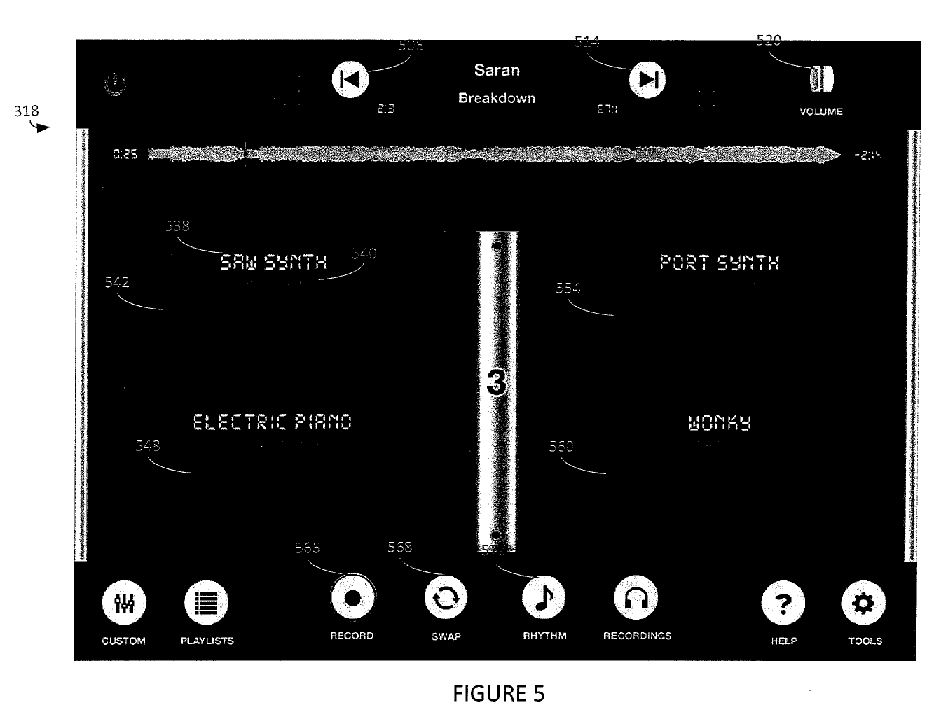

FIG. 5 illustrates a graphical user interface (GUI) for multilayered media playback in accordance with embodiments of the present disclosure. The embodiment shown in FIG. 5 is for illustration only. Other embodiments could be used without departing from the scope of this disclosure.

The GUI of FIG. 5 is an embodiment of UI 318 of FIG. 3. UI 318 includes several user interface (UI) elements to manipulate multilayered media playback. UI 318 is displayed on touchscreen 202 to allow a user to interact with the UI elements of UI 318.

Buttons 506 and 514 provide for switching between different multilayered media files. Interaction with button 506 causes the application 162 to switch to a previous multilayered media file in a playlist. Interaction with button 514 causes the application 162 to switch to a subsequent multilayered media file in a playlist. Buttons 506 and 514 are associated with bits b2 and b0, respectively, of switch status payload 406. Changes to switch status bits b2 and b0 are displayed via UI 318 on buttons 506 and 514. A user can manipulate either switches 326 of triggering device 204 or buttons 506 and 514 displayed on UI 318 to change between a last song and a next song.

Volume slider 520 provides for adjusting volume of playback of multilayered media files. Interaction with volume slider 520 causes the application 162 to increase or decrease a volume of playback of a multilayered media file, such as multilayered media file 216. Volume slider 520 is associated with the byte of encoder status payload 408. Changes to the byte of encoder status payload 408 are displayed via UI 318 on volume slider 520. A user can manipulate either switches 326 of triggering device 204 or volume slider 520 displayed on UI 318 to adjust volume.

Display of beam 542 on UI 318 includes text elements 538 and 540. Text element 538 indicates a name of the instrument and layer of media associated with beam 542. Text element 540 indicates additional information about the instrument and layer of media associated with beam 542. As illustrated by text elements 538 and 540, the layer of media associated with beam 542 is an instrument named “saw synth” with a pulse of one sixteenth note. Text of text elements 538 and 540 and which type of attribute is shown in text element 540 can be defined in a beam layout of multilayered media file 216, such as in definition file 208. Beam 542 on UI 318 is active, as indicated by the display of beam 542 as compared to beams 548, 554, and 560, which are not active. Beam 542 is associated with a bit, e.g., bit b0, of sensor status payload 404. Changes to bit b0 of sensor status payload 404 are displayed via UI 318 and beam 542. A user can interact with either the beam break system of triggering device 04 or beam 542 displayed on UI 318 to trigger and control playback of a layer or musical program of multilayered media.

Button 566 allows for recording output of the current playback of multilayered media. When button 566 is interacted with via a tap gesture, processing unit 140 causes the combined media that includes all of the active layers of media of multilayered media file 216 being played to be recorded to a memory, such as memory 160 of electronic device 102, so that the recorded combined media can be played back without having to re-create all of the user inputs and touch gestures that created the current playback. Button 566 is associated with bit b6 of switch status payload 406. Changes to switch status bit b6 are displayed via UI 318 and button 566. A user can manipulate either a switch of switches 326 associated with bit b6 of switch status payload 406 of triggering device 204 or button 566 displayed on UI 318 to change whether a session is being recorded.

Button 568 allows for swapping instruments or beam layouts in a current playlist session. When button 568 is interacted with via a tap gesture, processing unit 140 causes the functionality of one or more beams 542, 548, 554, and 560 or triggers to be swapped. Button 568 is associated with bit b1 of switch status payload 406. Changes to switch status bit b1 are displayed via UI 318 and button 568. A user can manipulate either a switch of switches 326 associated with bit b1 of switch status payload 406 of triggering device 204 or button 568 displayed on UI 318 to perform a swap.

Button 570 allows for starting or stopping a rhythm layer of media. When button 570 is interacted with via a tap gesture, processing unit 140 causes the rhythm layer of media of multilayered media file 216 to be output via speaker 130. Button 570 is associated with bit b3 of switch status payload 406. Changes to switch status bit b3 are displayed via UI 318 and button 570. A user can manipulate either a switch of switches 326 associated with bit b3 of switch status payload 406 of triggering device 204 or button 570 displayed on UI 318 to start or stop the rhythm layer of multilayered media.

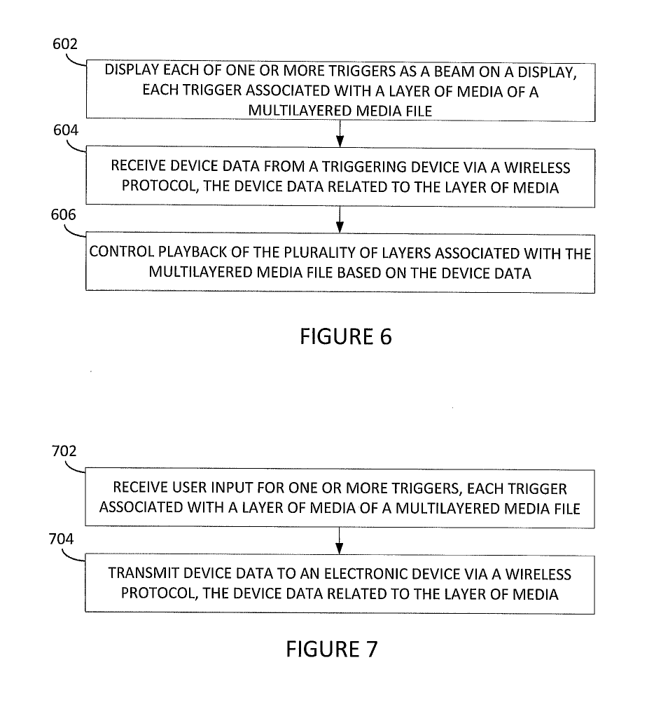

FIG. 6 illustrates a flowchart for multilayered music playback based on wireless device data. While the flowchart depicts a series of sequential steps, unless explicitly stated, no inference should be drawn from that sequence regarding specific order of performance of steps, or portions thereof, serially rather than concurrently or in an overlapping manner, or performance the steps depicted exclusively without the occurrence of intervening or intermediate steps. The process depicted in the example is implemented by any suitably configured electronic device, such as electronic device 102 of FIG. 1.

At step 602, each of one or more triggers is displayed as a beam on display 155 of electronic device 102. Each trigger is associated with a bit of a sensor status payload of a packet of device data that is communicated wirelessly between electronic device 102 and triggering device 204. Each trigger is associated with a layer of media of a multilayered media file.

At step 604, electronic device 102 receives device data from triggering device 204 via a wireless protocol. The device data is related to the layer of media.

At step 606, electronic device 102 controls playback of the plurality of layers associated with the multilayered media file based on the device data. Electronic device 102 also controls display of UI 318 based on the device data.

FIG. 7 illustrates a flowchart for multilayered music playback based on wireless device data. While the flowchart depicts a series of sequential steps, unless explicitly stated, no inference should be drawn from that sequence regarding specific order of performance of steps, or portions thereof, serially rather than concurrently or in an overlapping manner, or performance the steps depicted exclusively without the occurrence of intervening or intermediate steps. The process depicted in the example is implemented by any suitably configured electronic device, such as triggering device 204 of FIG. 2.

At step 702, triggering device 204 receives user input for one or more triggers. Each trigger is associated with a bit of a sensor status payload of a packet of device data that is communicated wirelessly between electronic device 102 and triggering device 204.

At step 704, triggering device 204 transmits device data to an electronic device via a wireless protocol, the device data related to the layer of media. Each trigger is associated with a layer of media of a multilayered media file.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of operating an electronic device for playback of a multilayered media file, the method comprising:
receiving device data from a triggering device via a wireless protocol, the device data related to a plurality of triggers of the triggering device, each of the triggers is associated with a distinct layer of a plurality of layers of the multilayered media file; and
controlling playback of the plurality of layers of media associated with the multilayered media file based on the device data.

2. The method of claim 1, further comprising:
displaying each of one or more of the triggers as a beam on a display of the electronic device.

3. The method of claim 1, wherein the device data is received in accordance with a wireless personal area network (WPAN) protocol.

4. The method of claim 3, wherein the WPAN protocol is Bluetooth Low Energy (BLE).

5. The method of claim 1, wherein the device data is received as a packet that comprises one or more of a sensor status payload, a switch status payload, an encoder status payload, and an error status payload.

6. The method of claim 5, wherein the sensor status payload comprises one or more sensor bits associated with the plurality of triggers and each sensor bit is associated with a trigger of the triggering device.

7. The method of claim 1, wherein:
the multilayered media file comprises a plurality of musical programs,
each of the musical programs comprises a subset of a predetermined musical composition,
each of the musical programs is correlated to each other,
each of the musical programs comprises sound elements configured to generate sympathetic musical sounds, and
one of the triggers is associated with one of the musical programs.

8. The method of claim 5, wherein the switch status payload comprises one or more status bits that indicate a status of one or more of a mute button of the triggering device, a record button of the triggering device, a volume down button of the triggering device, a volume up button of the triggering device, a rhythm button of the triggering device, a last song button of the triggering device, a swap button of the triggering device, and a next song button of the triggering device.

9. The method of claim 5, wherein the encoder status payload comprises a plurality of encoder bits wherein incrementally larger values are associated with increasing volume and incrementally smaller values are associated with decreasing volume.

10. The method of claim 9, wherein when a sensor bit of the sensor status payload indicates a trigger associated with the sensor bit is activated, changes to the plurality of encoder bits are associated with a change of an attribute of a layer associated with the trigger.

11. A method of a triggering device used for playback of a multilayered media file, the method comprising:
transmitting device data from a triggering device via a wireless protocol, the device data related to a plurality of triggers of the triggering device, each of the triggers is associated with a distinct layer of a plurality of layers of the multilayered media file,
wherein an electronic device that receives the device data controls playback of the plurality of layers of media associated with the multilayered media file based on the device data.

12. The method of claim 11, wherein each of one or more of the triggers is displayed as a beam on a display of the electronic device.

13. The method of claim 11, wherein the device data is transmitted in accordance with a wireless personal area network (WPAN) protocol.

14. The method of claim 13, wherein the WPAN protocol is Bluetooth Low Energy (BLE).

15. The method of claim 11, wherein the device data is transmitted as a packet that comprises one or more of a sensor status payload, a switch status payload, an encoder status payload, and an error status payload.

16. The method of claim 15, wherein the sensor status payload comprises one or more sensor bits associated with the plurality of triggers and each sensor bit is associated with a trigger of the triggering device.

17. The method of claim 11, wherein:
the multilayered media file comprises a plurality of musical programs,
each of the musical programs comprises a subset of a predetermined musical composition,
each of the musical programs is correlated to each other,
each of the musical programs comprises sound elements configured to generate sympathetic musical sounds, and
one of the triggers is associated with one of the musical programs.

18. The method of claim 15, wherein the switch status payload comprises one or more status bits that indicate a status of one or more of a mute button of the triggering device, a record button of the triggering device, a volume down button of the triggering device, a volume up button of the triggering device, a rhythm button of the triggering device, a last song button of the triggering device, a swap button of the triggering device, and a next song button of the triggering device.

19. The method of claim 15, wherein the encoder status payload comprises a plurality of encoder bits wherein incrementally larger values are associated with increasing volume and incrementally smaller values are associated with decreasing volume.

20. The method of claim 19, wherein when a sensor bit of the sensor status payload indicates a trigger associated with the sensor bit is activated, changes to the plurality of encoder bits are associated with a change of an attribute of a layer associated with the trigger.

21. An apparatus for playback of a multilayered media file, the apparatus comprising:
a receiver configured to receive device data from a triggering device via a wireless protocol, the device data related to a plurality of triggers of the triggering device, each of the triggers is associated with a distinct layer of a plurality of layers of the multilayered media file; and
one or more processors configured to control playback of the plurality of layers of media associated with the multilayered media file based on the device data.

22. The apparatus of claim 21, further comprising:
the one or more processors further configured to cause display of each of one or more of the triggers as a beam on a display of the apparatus.

23. The apparatus of claim 21, wherein the device data is received in accordance with a wireless personal area network (WPAN) protocol.

24. The apparatus of claim 23, wherein the WPAN protocol is Bluetooth Low Energy (BLE).

25. The apparatus of claim 21, wherein the device data is received as a packet that comprises one or more of a sensor status payload, a switch status payload, an encoder status payload, and an error status payload.

26. The apparatus of claim 25, wherein the sensor status payload comprises one or more sensor bits associated with the plurality of triggers and each sensor bit is associated with a trigger of the triggering device.

27. The apparatus of claim 21, wherein:
the multilayered media file comprises a plurality of musical programs,
each of the musical programs comprises a subset of a predetermined musical composition,
each of the musical programs is correlated to each other,
each of the musical programs comprises sound elements configured to generate sympathetic musical sounds, and
one of the triggers is associated with one of the musical programs.

28. The apparatus of claim 25, wherein the switch status payload comprises one or more status bits that indicate a status of one or more of a mute button of the triggering device, a record button of the triggering device, a volume down button of the triggering device, a volume up button of the triggering device, a rhythm button of the triggering device, a last song button of the triggering device, a swap button of the triggering device, and a next song button of the triggering device.

29. The apparatus of claim 25, wherein the encoder status payload comprises a plurality of encoder bits wherein incrementally larger values are associated with increasing volume and incrementally smaller values are associated with decreasing volume.

30. The apparatus of claim 29, wherein when a sensor bit of the sensor status payload indicates a trigger associated with the sensor bit is activated, changes to the plurality of encoder bits are associated with a change of an attribute of a layer associated with the trigger.
